(19) United States
(12) Patent Application Publication
(10) Pub. No.: US 2012/0061480 A1
(43) Pub. Date: Mar. 15, 2012

(54) PORTABLE INFORMATION DISPLAY DOCKABLE TO A BASE THERMOSTAT

(75) Inventors: Jorge DELIGIANNIS, Ottawa (CA); Niraj BHARGAVA, Ottawa (CA)

(73) Assignee: ENERGATE INC., Ottawa (CA)

(21) Appl. No.: 13/229,013

(22) Filed: Sep. 9, 2011

Related U.S. Application Data
(60) Provisional application No. 61/381,559, filed on Sep. 10, 2010.

(51) Int. Cl. G05D 23/19; G01K 15/00; H02J 7/00; G08B 29/00

(52) U.S. Cl. 236/51; 340/5.2; 374/1; 320/107; 374/E15.001

(57) ABSTRACT

A thermostat system is provided that comprises a base thermostat for providing basic thermostat control and a portable information display (PID) unit, or dockable display, that provides an improved user interface. The PID unit can be docked to the base thermostat by being releasably mounted on top of a front portion of the base thermostat. The base thermostat provides control of an environmental control system, allowing the regulation of the temperature in a building. The PID unit may be used when it is mounted to the base thermostat or un-mounted from the base thermostat. The PID unit provides an improved user interface and experience over the base thermostat.

### CROSS-REFERENCE TO RELATED APPLICATIONS

This application claims the benefit of U.S. Provisional Patent Application No. 61/381,559 filed Sep. 10, 2010, the entirety of which is hereby incorporated by reference.

### TECHNICAL FIELD

The present disclosure relates to thermostats and in particular to a portable information display unit dockable to a base thermostat.

### BACKGROUND

Environmental control in residential homes is typically performed by a centrally located thermostat. The thermostat is hardwired to an environmental control system such as radiant heating source such as a boiler, a forced air heating source such as a furnace, air conditioner, ventilator, or what may be collectively called heating ventilation and cooling (HVAC) system. The thermostat includes a temperature sensing mechanism in order to control the environmental control system to maintain a desired temperature. The thermostat is typically located centrally within the home to control house temperature. The environmental control system can provide power to the thermostat typically via 24 volts alternating current (VAC) from the environmental control system transformer so that only wiring between the environmental control system and thermostat is required without a separate power connection.

Centrally located thermostats typically include a limited display for thermostat control information and provide a limited subset of functions for the user to interface with. Newer centrally located thermostats may incorporate a larger display enabling an improved user interface for displaying and inputting thermostat control information but require direct wiring to the environmental control system. Although the larger displays of newer thermostats may provide an improved user interface, the increased costs and functionality may be undesirable for some users particularly to replace an existing thermostat provided by a utility company or provided with the environmental control system. In addition utilities may not want to incur the additional cost of providing an advanced thermostat as the standard installation due to the added cost and complexity. As such, low cost display thermostats are most commonly provided by utilities or installers when installing environmental control systems. In order for a user to have additional functionality beyond the basic functions of a thermostat they are required to replace their existing thermostat.

Additionally, the central placement of a thermostat may not be ideal for all users at all times. For example, the temperature readings by the thermostat may not be consistent within the living space layout or the occupant's movement or living patterns throughout the day. For example activities in the kitchen may impact the thermostat reading and at night time the bedroom temperature may be of more concern than the temperature in a family room location in which the centrally located thermostat is positioned. As such, the temperature control provided by the centrally located thermostat may not be ideal for all users all the time.

Accordingly, thermostat systems and methods that enable an improved user experience remain highly desirable.

### BRIEF DESCRIPTION OF THE DRAWINGS

Further features and advantages of the present disclosure will become apparent from the following detailed description, taken in combination with the appended drawings, in which:

FIG. 1 shows an illustration of a portable information display unit and a base thermostat in a building;

FIGS. 2a and 2b show schematic representations of the portable information display unit and the base thermostat;

FIG. 3 shows a schematic representation of the docked portable information display unit mounted to the base thermostat;

FIGS. 4a, 4b, and 4c show additional views of schematic representations of a portable information display unit and base thermostat;

FIG. 5 shows a schematic representation of a side view of the portable information display unit on a surface standing upright;

FIG. 6 shows a schematic illustration of components of the base thermostat;

FIG. 7 shows a schematic illustration of components of the portable information display unit;

FIG. 8 shows a schematic of an example floor plan of a home in which the portable information display unit is used;

FIG. 9 shows a method of controlling an environmental control system settings based on a location of the portable information display unit; and

FIG. 10 shows a method of securing wireless communication between the portable information display unit and the base thermostat.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

In accordance with an aspect of the present disclosure there is provided a portable information display (PID) unit comprising: a wireless communication interface for communicating with a base thermostat coupled to an environmental control system; a docking mechanism for releasably mounting the PID unit to the base thermostat; and a display for displaying environmental control system information retrieved from the base thermostat.

In accordance with another aspect of the present disclosure there is provided a thermostat system comprising a base thermostat coupled to an environmental control system to control operation of at least one component of the environmental control system; and a portable information display (PID) unit comprising a display, providing a docking mechanism to releasably mount the PID unit to the base thermostat, the PID unit communicating with the base thermostat to enable controlling the base thermostat via the PID unit.

In accordance will yet another aspect of the present disclosure there is provided a method of operating a thermostat system, the method comprising: detecting, in a base thermostat, when a portable information display (PID) unit is docked to the base thermostat; establishing communication between the base thermostat and the PID unit; and exchanging security information between the base thermostat and the PID unit; wherein the security information is used to enable wireless communication between the base thermostat and the PID unit when undocked.

In accordance with yet another aspect of the present disclosure there is provided a method of controlling an HVAC system comprising: tracking a position of a portable information display (PID) unit; and controlling the HVAC system in accordance with HVAC control settings associated with the tracked position of the PID unit.

Smart grid networks enable utilities to predict and intelligently respond to the behaviour and actions of all electric power users connected to it by providing information to the consumer and enable intelligent load control. As the environmental control system can be one of the largest electrical loads in the home, the disclosed thermostat system can also provide energy management functions and smart grid connectivity not provided by typical thermostats. A thermostat system is described herein that comprises a base thermostat for providing basic thermostat control and a portable information display (PID) unit, or dockable display, that provides an improved user interface. The PID unit can be docked to the base thermostat by being releasably mounted on top of a front portion of the base thermostat. The base thermostat provides control of an environmental control system, allowing the regulation of the temperature in a building and can provide interfaces with networks or other devices in the home and the smart grid. The PID unit may be used when it is mounted to the base thermostat and also interface with the base thermostat for charging, calibration or security. When un-mounted the PID unit can be used to control the functions of the base thermostat or be used as a remote thermostat to augment the base thermostat. The PID unit provides an improved user interface and experience over the base thermostat and access to functions not easily available through the interface of the base thermostat. Advantageously, the PID unit may be commissioned in the home without requiring the base thermostat to be removed enabling the consumer to upgrade an existing thermostat's functionality.

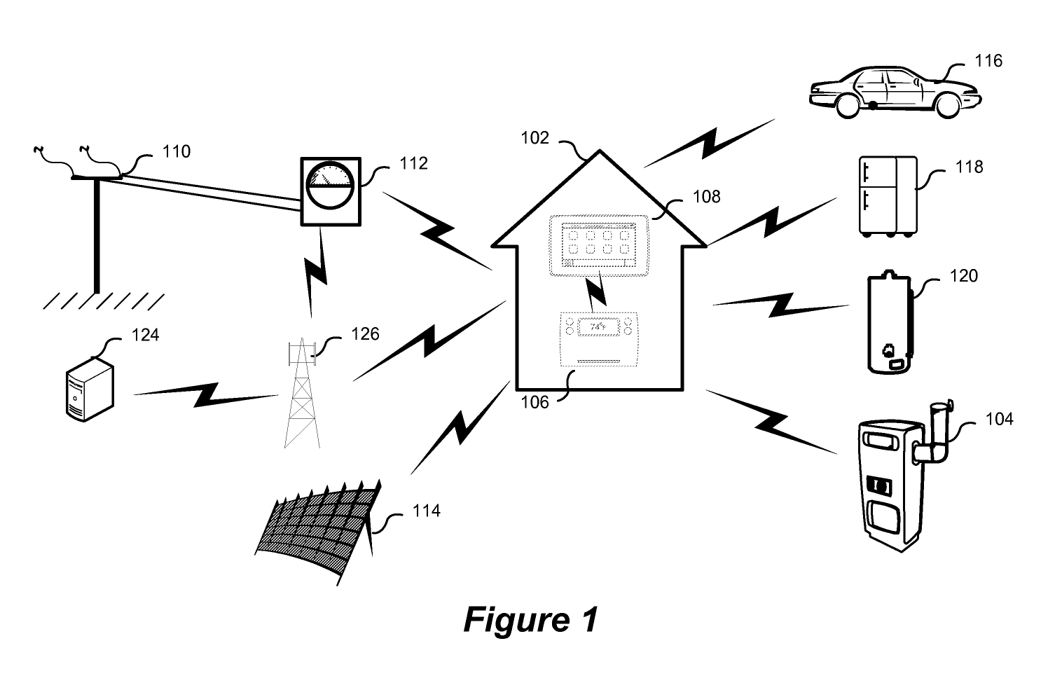

FIG. 1 depicts in a schematic illustration of the PID unit and the base thermostat in a building. A residential building or home 102 is shown where environmental control system and thermostat controls are located within the structure to affect an internal environmental condition. The environmental condition is typically temperature, although other environmental conditions may be controlled such as humidity, air cleanness, etc. may be controlled by the environmental control system. The building 102 includes a base thermostat 106 that includes an environmental sensor for sensing the environmental condition and controlling the environmental control system accordingly, such as turning on a heat source such as a furnace 104 or boiler to heat the environment by switching 24 VAC of a transformer wired from the furnace to the thermostat, turning on air conditioning to cool the environment, turning on a fan to increase air circulation or ventilation and improve air quality or other appropriate environmental control system control. The thermostat may utilize analog or digital communication to interface with the environmental control system or be connected to an intermediary device for interface and control of one or more components. The base thermostat includes a display and control inputs for setting and adjusting environmental control system settings, such as a heating/cooling schedule, desired temperatures, etc. Advantageously, the base thermostat 106 may provide a cost effective thermostat suitable for a number of consumers with limited interface display and interaction functionality.

A PID unit 108 that includes a large display can communicate with the base thermostat and provide an improved user interface and enable additional input means for setting, adjusting and displaying HVAC control settings. The PID unit provides a user interface that enables the user to access or program information not directly accessible through the interface of the base thermostat. Additionally, the PID unit 108 can be releasably mounted to the base thermostat 106 to provide an improved display without requiring the base thermostat 106 to be replaced. The base thermostat 106 and the PID unit 108 that provides an improved user interface may be used to interface with, and possibly control, additional components. For example, the residential building 102 is connected to the smart grid or power grid 110 through a metering device 112, or by networking provided through the metering device. The base thermostat 106 may interface with the metering device or an associated utility network or smart grid, either wired or wirelessly, in order to determine an amount of power consumed, which may be displayed on the base thermostat 106 or on the PID unit 108 using a graphical representation. The thermostat may also interface with residential power sources, such as for example a solar array 114, to monitor power production. The base thermostat 106 and/or the PID unit 108 may also display information from smart appliances refrigerators 118, hot water heaters 120, etc. and consumption or charging states of electric devices such as electric or hybrid electric automobiles 116. The base thermostat 106 and/or the PID unit 108 may additionally control appliances, for example by controlling load switches, which could also report consumption for the appliance, or enabling or disabling devices in order to reduce the cost of consumed power or in response to utility directed load control events. In addition to traditional heating and cooling function the thermostat may act as an energy gateway for monitoring and controlling power consumption and implementing demand response control either locally or in combination with the smart grid.

The base thermostat 106 and/or the PID unit 108 may also be connected to a network 126, for communicating with one or more computer servers 124 through one or more of the wireless interfaces. The base thermostat 106 and/or the PID unit 108 may use the connection to retrieve information, such as prevailing electricity rate information, current weather, weather forecast, consumption patterns, programming information, software updates and other information that may be presented or used by the PID unit 108. Additionally, the network connection may allow control of the base thermostat and the environmental control system, from a remote location.

The base thermostat 106 is typically mounted in a central, or convenient, location of the residential building 102, and provides control of an environmental condition such as the temperature for the residence 102. The base thermostat may be connected to a furnace by a 24 VAC connection using standard wiring or from a main AC power of the residence 102. The base thermostat 106 may act as a switch for connecting the circuit of the 24 VAC transformer that provides the power to the control circuit of furnace 104. The base thermostat 106 may be connected to the 24 VAC power line through a ground line adapter that allows the base thermostat 106 to receive power from the 24 VAC circuit as well as send furnace control information over the 24 VAC circuit, reducing the number of wires required to install the base thermostat. Alternatively the base thermostat may utilize additional analog lines or digital communication to interface with the environmental control system or associated components.

The PID unit 108 provides an improved user interface to the base thermostat 106. Advantageously, the PID unit 108 may be mounted to the base thermostat 106, covering the face of the base thermostat 106. With the PID unit 108 mounted or docked to the base thermostat 106, it provides a centrally mounted thermostat with a large display. Additionally, the PID unit 108 may be un-mounted or undocked from the base thermostat 108 and communicate with the base thermostat 106 remotely to control operation of the environmental control system components such as the furnace 104.

The PID unit 108 may include an environmental sensor for sensing conditions in the vicinity of the PID unit 108. The PID unit 108 may communicate the sensed environment to the base thermostat 106 which may be used to control the environmental control system or other components or devices. The PID unit 108 with the environmental sensor may be used to provide temperature control for a room the PID unit 108 is located in, rather than based on the temperature sensed by the base thermostat 106 or be used in combination or augment the base thermostat or other sensors within the home.

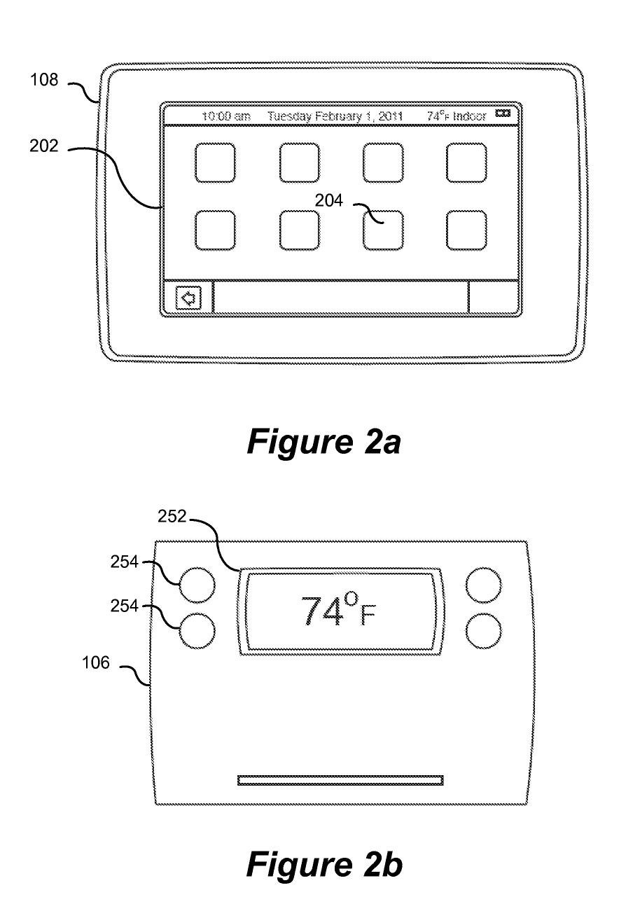

FIG. 2a depicts in a schematic representation of an illustrative PID unit 108. As depicted the PID unit 108 comprises a large display screen 202. The display screen may be a touch sensitive screen allowing user interactions to control function of the PID unit 108. The PID unit 108 provides a graphical display, represented by icons 204 to present control functions and information to a user of the display. The graphical display provides functionality accessible by the user to monitor and control the environmental control system and associated components. For example, it may be used to set a current desired temperature, set a heating or cooling schedule, or change or adjust other environmental condition parameters that are affected by the environmental control system. The PID unit may also enable the user to monitor consumption information from the utility or of energy sources, such as solar power, or sinks, such as appliances in the home and implement load control functions. The large display may be used to display additional information, such as current power usage, historic power usage, projected power usage, costs associated with power usage, current temperature, current weather conditions and other information that may be useful to the user. Additionally, the PID unit 108 may be used to control or adjust smart appliances or load control devices, such as controlling a time to charge a plugged in electric vehicle, time to turn on a clothes drier, etc.

FIG. 2b depicts in a schematic representation of an illustrative base thermostat 106. The base thermostat 106 comprises a display 252 and one or more input controls 254. The display and input controls of the base thermostat 106 may be a touch screen, or buttons 254 as depicted. The base thermostat provides limited user functionality for controlling the environmental control system. The base thermostat includes an environmental sensor such as a temperature sensor that is used to monitor an environmental condition and control the environmental control system in order to maintain the environmental condition within a set threshold.

The base thermostat 106 includes a communication interface for communicating with the PID unit 108. The communication interface may be a wireless communication interface when the PID unit 108 is undocked. The base thermostat 106 includes functionality for setting and adjusting environmental control system settings, such as a desired temperature threshold. The base thermostat 106 includes functionality for allowing the environmental control system settings to be set or adjusted from external devices, including the PID unit 108. The environmental control system settings may also be set or adjusted from a remote computer over the network connection. The base thermostat 106 may be able to interface and control devices in the home or smart grid but the programming or display of information may not be available through the interface provided on the base thermostat and may require the PID unit 108 for programming.

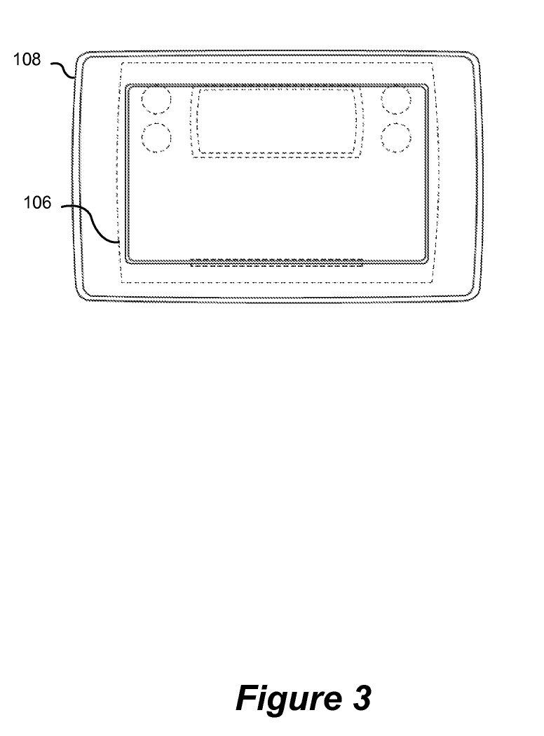

FIG. 3 depicts in a schematic, a representation of the portable information display unit mounted to the base thermostat. The PID unit 108 may be mounted and un-mounted from the base thermostat 106. The PID unit 108 is mounted or docked over the base thermostat 106 represented by the dashed lines. When mounted to the base thermostat 106, the PID unit 108 covers the display 252 and the face of the base thermostat 106 so that the mounted PID unit 108 appears as the only thermostat control.

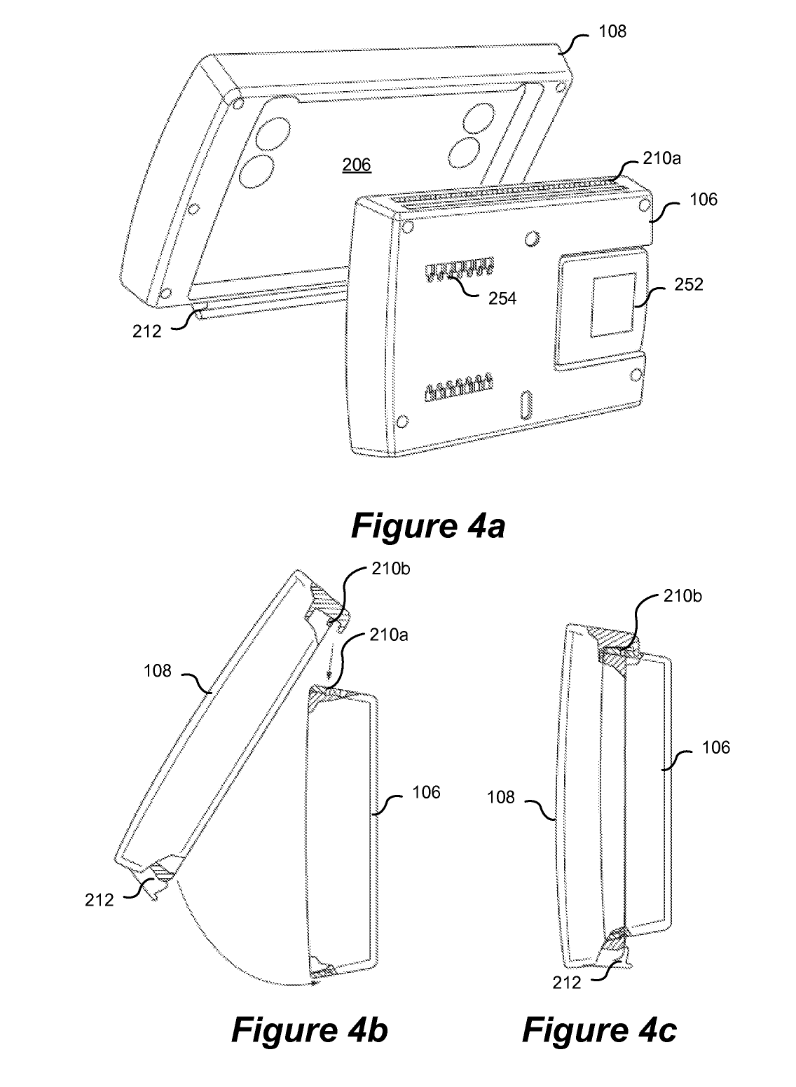

FIGS. 4a, 4b, and 4c depict additional views of schematic representations of the portable information display unit 108 and the base thermostat 106. As depicted in FIG. 4a, the PID unit 108 comprises a recessed portion 206 on the back face of the PID unit 108. The recessed portion 206 is sized to receive the base thermostat 106. In addition to the recessed portion 206 of the PID unit 108, the base thermostat 106 and the PID unit 108 may include a docking mechanism for securing the PID unit 108 to the base thermostat 106. The docking mechanism may be provided by various means and may engage the base thermostat to attach the PID unit 108 securely when mounted. As depicted, the PID unit 108 can couple with the base thermostat 106 via an interface 210a to provide power and/or a data interface to the PID unit 108 shown on the top of the base thermostat 106. However, the interface 210a may be located on any location of the base thermostat 106 that can be in contact with a mating connection on the PID unit 108. The PID unit 108 includes corresponding power and/or data interfaces 210b that are received by the base thermostat 106 when the PID unit 108 is mounted to the front portion of the base thermostat 106. The docking mechanism may further comprise a latch 212 on the bottom of the PID unit 108 for engaging with and securing to the base thermostat 106. The docking mechanism may be positioned on the top, bottom, and side or integrated into the back of the PID unit to mount the PID unit 108 to the base thermostat 106. The docking mechanism may utilize a latch, spring mechanism, friction fit, or slide mechanism to mount the PID unit to the display when docked.

The base thermostat 106 may also comprise a removable communication module 252. The removable communication module 252 may provide one or more wireless communication interfaces. The base thermostat 106 may also include a plurality of wire connections 254 for connecting to the environmental control system such as the 24 VAC transformer circuit or other control or wiring schemes such as direct digital communication. A direct data interface between the PID unit 108 and base thermostat 106 may not be required if wireless communication between the two devices is exclusively utilized, in this case only a power connection between the two devices would be required.

As depicted in FIG. 4b, the PID unit 108 may be mounted to the base thermostat 106 by engaging the PID unit 108 with the data and power interfaces of the base thermostat 106 and then engaging the latch 212 of the PID unit 108 with the base thermostat 106. As depicted in FIG. 4c, the PID unit 108 receives at least a portion of the base thermostat 106. When the PID unit 108 is docked to the base thermostat 106, the latch 212, or other engagement mechanism, secures the PID unit 108 so that the touch interface may be used to control the environmental control system without undocking the PID unit 108 from the base thermostat 106.

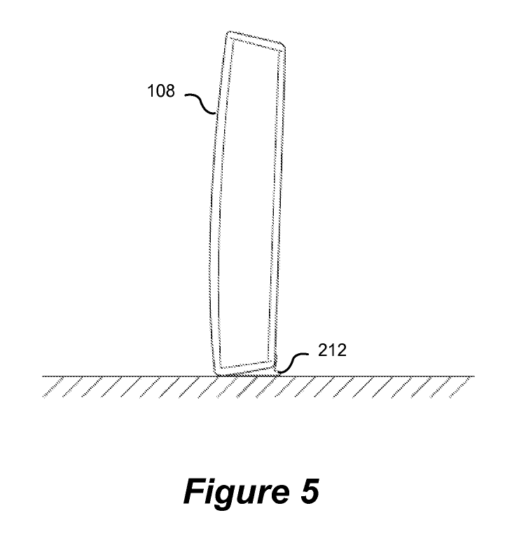

When the PID unit 108 is un-mounted from the base thermostat 106, it may be carried around by a user and used as a remote thermostat to control the base thermostat 106 and the environmental control system or other interfacing components or devices. As depicted in FIG. 5, when un-mounted, the latch 212 of the PID unit 108 may be used to stand the PID unit up on a surface. Alternatively a stand may be integrated into the PID unit 108 or the PID unit may be able to stand upright independently. An orientation sensor or tilt sensor may be utilized to determine the orientation of the PID unit 108 and selectively enable or disable functions of the PID unit 108 such as a temperature sensor if the PID unit 108 is face down and would result in potentially inaccurate readings.

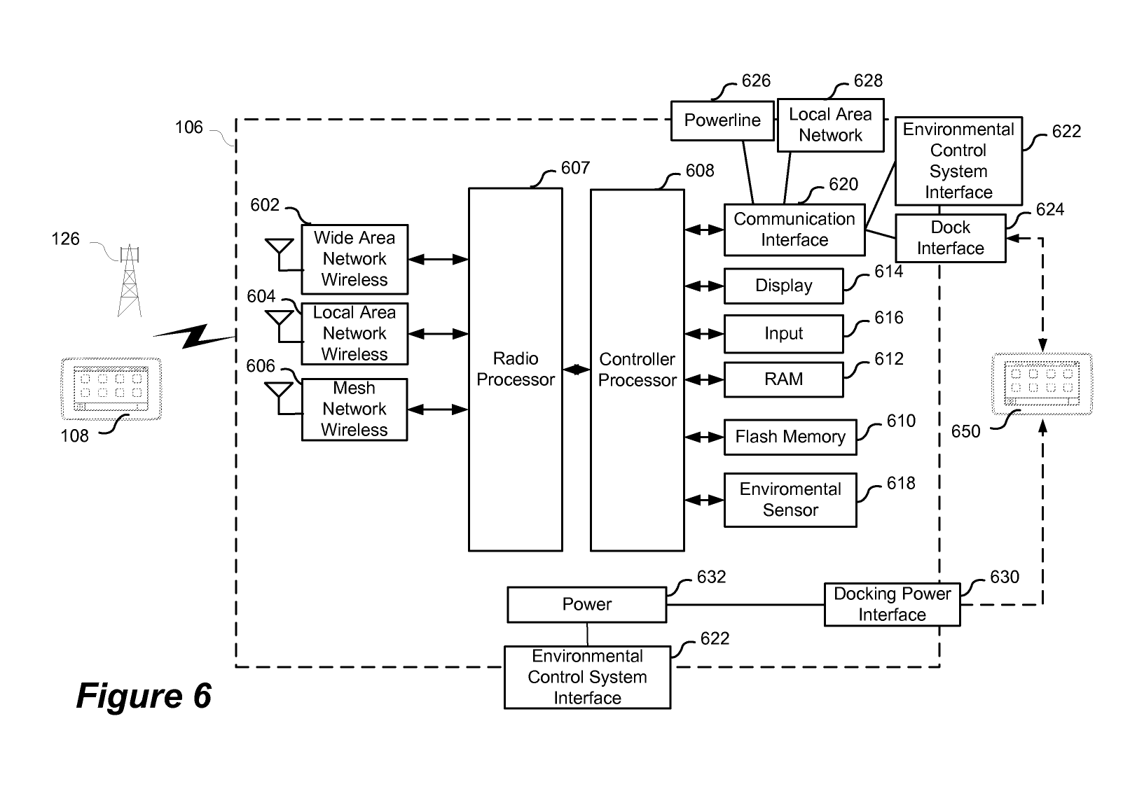

FIG. 6 depicts in a schematic illustrative components of a base thermostat 106. The base thermostat 106 may comprise one or more radio interfaces for wireless communication. The radio interfaces may include a wireless wide area network (WAN) interface 602, a wireless local area (LAN) network interface 604 peer-to-peer or bridge connections, a wireless mesh network interface 606 or other wireless communication interfaces. The wireless communication interfaces may be used to communicate with the PID unit 108 or other components or local or wide area networks 126 as previously described. The base thermostat 106 may include a radio processor 607 to provide high level control of the wireless communication interfaces and allows different wireless communication interfaces to be seamlessly used. As such, one wireless interface may be substituted with another without requiring modifications to the base thermostat. The wireless communication interfaces may be utilized for interfacing with a smart grid network, smart grid enabled devices, smart devices or load control switches in the home or for sending or receiving information for control or display on the PID unit 108.

Base thermostat 106 further includes a controller 608 that executes instructions to provide the functionality of the base thermostat 106. The instructions may be stored in memory of the base thermostat 106. The memory may be provided by flash memory 610 or random access memory (RAM) 612. The controller 608 communicates with various components of the base thermostat 106 including the radio processor 607, as well as a display 614 and an input control 616 such as input buttons. The controller 608 communicates with an environmental sensor 618 that senses an environmental condition being controlled or may receive input from one or more remote sensors located inside or outside of the home, those sensors wired or connected wirelessly to the base thermostat 106. The base thermostat further comprises a communication interface 620 that allows the base thermostat 106 to communicate with one or more devices using various types of interfaces. The interfaces may include an environmental control system interface 622 for communicating with or controlling environmental control system components such as a furnace or boiler, using digital or analog control or signalling. A dock interface 624 for communicating with the PID unit 108 when it is mounted to the base thermostat 106 may also be provided. Other interfaces may include a power line interface 626 and a local area network interface 628, each of which may be used to communicate with other devices in the building The base thermostat 106 further includes a docking charge interface 630 for powering and charging the PID unit 108 when it is mounted to the base thermostat 106. The docking charge interface 630 receives power for charging from a power interface 632 of the base thermostat 106 from the environmental control system such as provided by the 24 VAC transformer circuit, or by other common voltage control interface. Although the base thermostat 106 is shown as having a radio processor 607 and controller processor 608, it should be understood that functions may be combined in a single processor or further divided among discrete components. The functions of the docking power interface 630 and dock interface 624 may be provided through a common connector interface and may utilize a common standard such as the universal serial bus (USB) standard that can provide communication and power interfaces simultaneously.

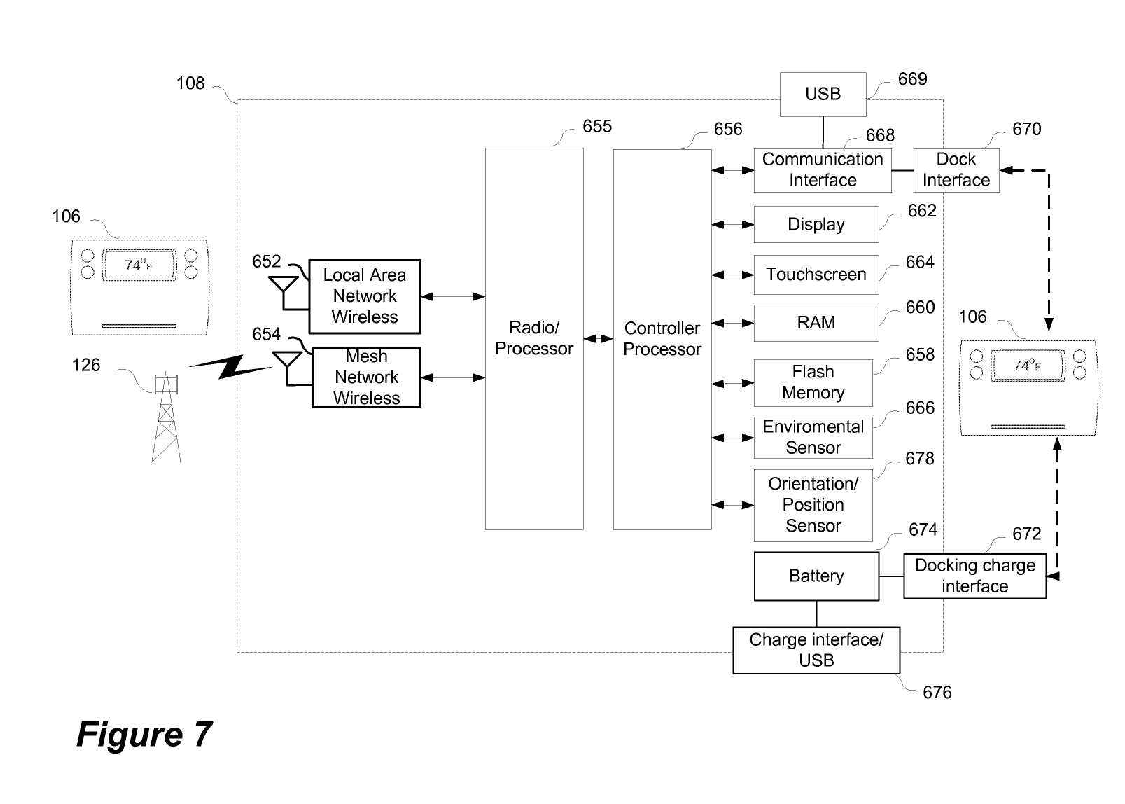

FIG. 7 depicts in a schematic illustration of the components of a PID unit 108. The PID unit 108 may comprise one or more radio interfaces for wireless communication with the base thermostat 106 when the PID unit 108 is un-mounted. The radio interfaces may include a wireless local area network (LAN) interface 652 peer-to-peer or bridge connections, a wireless mesh network interface 654 or other wireless communication interfaces. The wireless communication interfaces may be used to communicate with the base thermostat 106, the smart grid or other components or to retrieve or provide data to devices or services through one or more networks 126. The PID unit 108 may include a radio processor 655 to provide high level control of the wireless communication interfaces and allow different wireless communication interfaces to be used seamlessly. As such, one wireless interface may be substituted with another without requiring modifications to the PID unit 108.

PID unit 108 further includes a controller processor 656 that executes instructions to provide the functionality of the PID unit. The instructions may be stored in memory of the PID unit 108. The memory may be provided by flash memory 658 or random access memory (RAM) 660. The controller 656 communicates with various components of the PID unit 108 including the radio processor 655, as well as a display 662 and a touch screen input control 664. The controller 656 communicates with an environmental sensor 666 that senses an environmental condition that may be used to control the environmental control system or combined with the other sensor in the base thermostat 106 or remotely located. When the PID unit 108 is docked with the base thermostat 106, the environmental sensor 666 of the PID unit 108 and the environmental sensor 618 may be calibrated relative to each other as they are in close proximity and should be sensing the same parameters. For example if the environmental sensor 666 is sensing a 1 degree temperature difference compared to the environmental sensor 618, an offset or adjustment factor may be applied to ensure consistency of the readings between the base thermostat 106 and PID unit 108. This may be performed periodically when docked or by user initiation.

The PID unit 108 further comprises a communication interface 668 that allows the PID unit 108 to communicate with one or more devices using various types of interfaces such as a dock interface 670 for communicating with the base thermostat 106. The dock interface 670 is utilized when the PID unit 108 is mounted to the base thermostat 106 or one or more wireless interfaces. The base thermostat 106 further includes a docking charge interface 672 for powering the PID unit 108 and charging its battery. The battery 674 may also be charged and the PID 108 powered through a charge interface 676 by other power sources such as a wall outlet power adapter or via a USB connection 669. The USB connection 669 may also be used for programming or data exchange with a local network. The PID unit 108 may further include orientation and/or position sensors 678, such as accelerometers or triangulation components, such as a global positioning system (GPS) receiver, to determine a location of the PID unit 108 within the building. The wireless network information may be used in conjunction with the orientation and/or position sensors 678 to determine a location of the PID unit 108. Although the PID unit 108 is shown as having a radio processor 655 and controller processor 656, it should be understood that functions may be combined in a single processor or further divided among discrete components. The PID unit 108 may also include an ambient light sensor to modulate the screen brightness and conserve power whenever possible; a proximity sensor to activate the screen only when the PID unit 108 user is close to it; a speaker or equivalent for audible alarms and verbal prompts as well as a microphone for voice commands. These features may be too expensive to include with the base thermostat 106 but included with the PID unit 108, they provide the needed enhancements to provide a richer user experience in controlling their environment and manage energy use.

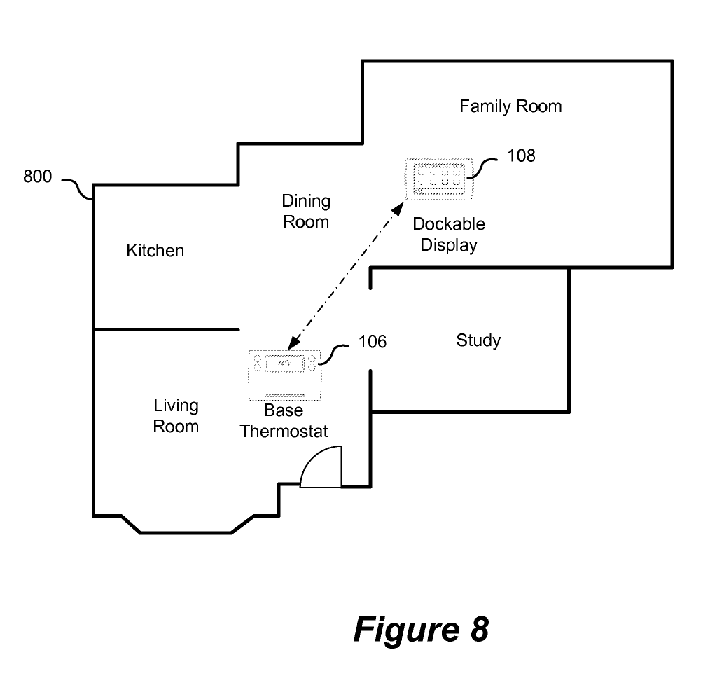

FIG. 8 depicts in a schematic of a floor plan of a home 800 in which the PID unit 108 and base thermostat 106 is used. As depicted, the building has a plurality of rooms with the base thermostat 106 located in or near the living room and mounted in a permanent location. The PID unit 108 may be mounted to the base thermostat 106 and used as the display and input interface of the base thermostat 106 providing an improved user interface. The PID unit 108 may be undocked or un-mounted from the base thermostat 106 and moved to another room, such as the family room. While in the family room, the PID unit 108 may be configured to communicate the temperature sensed by the PID unit 108 back to the base thermostat 106. The base thermostat may be selectively configured to use the remotely sensed temperature, an averaged temperature using one or more sensor within the house or the base thermostat when controlling the environmental control system. As such, the temperature at the location of the PID unit 108, which is assumed to be the room of the user, can be controlled

Additionally, the PID unit 108 may use the position and/or orientation sensors to determine its location and adjust environmental control system settings based on its location. For example, if the environmental control system includes controllable dampers, the base thermostat 106 may control the dampers to reduce air flow to additional rooms, such as the study, when the PID unit 108 is in the family room. The base thermostat 106 or the PID unit 108 may associate environmental control system settings with different locations in the house such that when the PID unit 108 location is determined the associated environmental control system settings may be used to control the environmental control system accordingly. Similarly the location of the PID unit may be associated with other input sensors to providing input to the operation of the environmental control system. The position of the PID unit 108 may be determined in various ways, for example, GPS triangulation may be used or communication network timing or triangulation techniques. Additionally or alternatively, signals received from various wireless devices within the building may be used to determine the location of the PID unit 108. It is also possible for the PID unit 108 to determine its position relative to the base thermostat 106 by using accelerometers or motion sensors. The movement of the PID unit 108 as determined by the accelerometers may be aggregated since the last time the PID unit 108 was mounted to the base thermostat 106 in order to provide a distance and direction from the base thermostat 106. The various locations, whether determined absolutely or relative to the base thermostat 106 or other devices may be associated with a room location, which in turn may be associated with environmental control system control settings and/or sensors to use when the PID unit 108 is at a particular location and designate specific rooms or displays on the PID unit 108.

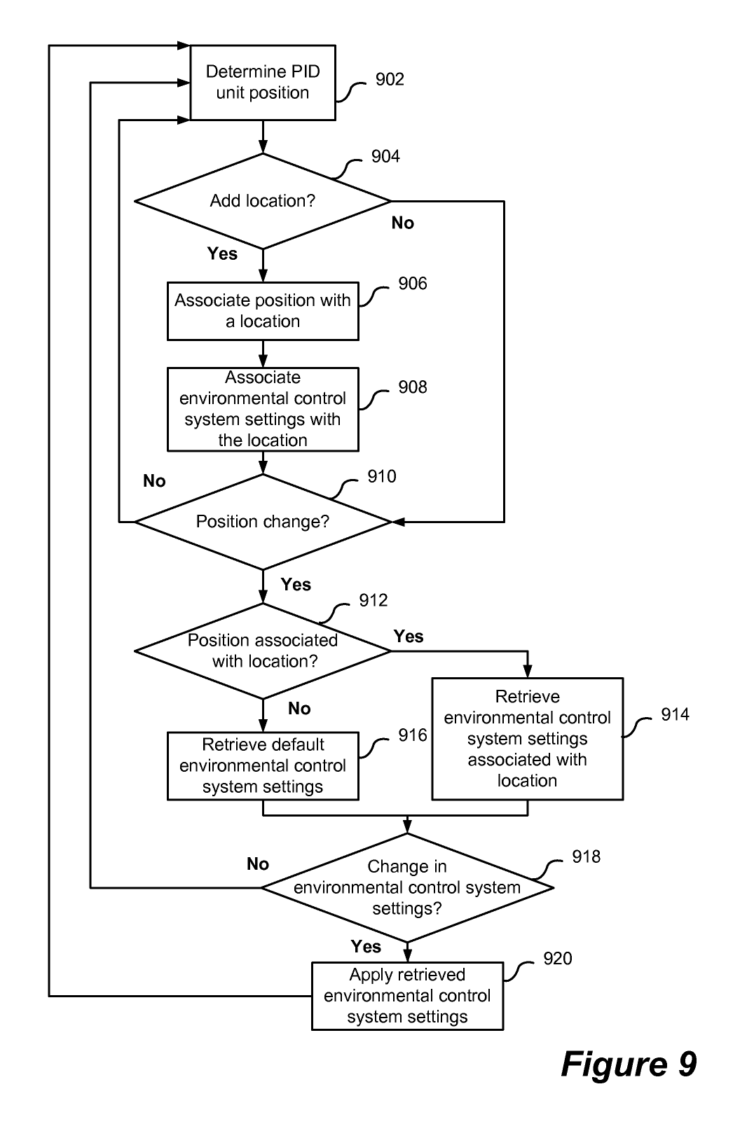

FIG. 9 depicts a method of controlling environmental control system control settings based on a location of the PID unit 108. The method 900 may be implemented by a processor in the PID unit 108 and begins with determining the position of the PID unit 108 relative to the base unit 106 (902). The position of the PID unit 108 may be tracked in various ways. For example, GPS, communication network triangulation, or position or motion sensors provided in the PID unit 108 may be used either alone or in combination to refine accuracy. If the position is determined based on accelerometers of the PID unit 108, the position may be tracked by continually monitoring the accelerometers and accumulating the movement of the PID unit since the PID unit was undocked from the base thermostat. Using the accelerometers provides a position of the PID unit 108 relative to the base thermostat 106. Alternatively an internal RF or mesh network timing and/or hop data may be utilized to determine a relative location within the home. The method determines if a location should be added (904), allowing users to use the PID unit 108 to map desired locations. If a location is to be associated with the position (Yes at 904), the current position is associated with the location or relative position (906) which may have an associated label such as family room, living room, kitchen etc. Using an existing location allows the extent of different locations to be stored. Once the current position is associated with the location, environmental control system settings can then be associated with the location (908). After adding the location and associating environmental control system settings with the location, or if no location is to be added (No at 904), the method determines if the position has changed (910). The current position may be compared to see if it has changed more than a threshold amount since the last position change. If the position has not changed (No at 910), the method returns to track the position (902). If the position has changed (Yes at 910) it is determined if the tracked position is associated with a location (912). If the position is associated with a location (Yes at 912), the environmental control system settings associated with the position are retrieved (914). If the position is not associated with a location (No at 912), default environmental control system settings are retrieved (916). Once environmental control system settings are retrieved it is determined if the retrieved environmental control system settings differ from the current environmental control system settings in use (918) and if they do differ (Yes at 918), the retrieved environmental control system settings are applied (920) or a confirmation is presented to the user to confirm that they want to apply the new settings. The method then returns to tracking the PID unit position. If the retrieved environmental control system settings do not differ from the current environmental control system settings (No at 918) the method returns to tracking the PID unit 108 position. Additional checks may be made prior to adjusting the environmental control system settings. For example, how long the PID unit has been in the current location may be checked so that the environmental control system settings are only adjusted if the PID unit 108 has been in the same location for a period of time in order to avoid adjusting the environmental control system settings as the PID unit 108 moves through different locations. Alternatively the location setting may be manually selected on the PID unit 108 if location determination is not available or the user wants to use default setting for another room. If location determination is possible but the user selects another room setting, the internal temperature sensing function may be overridden or may utilize other remote temperature monitoring devices.

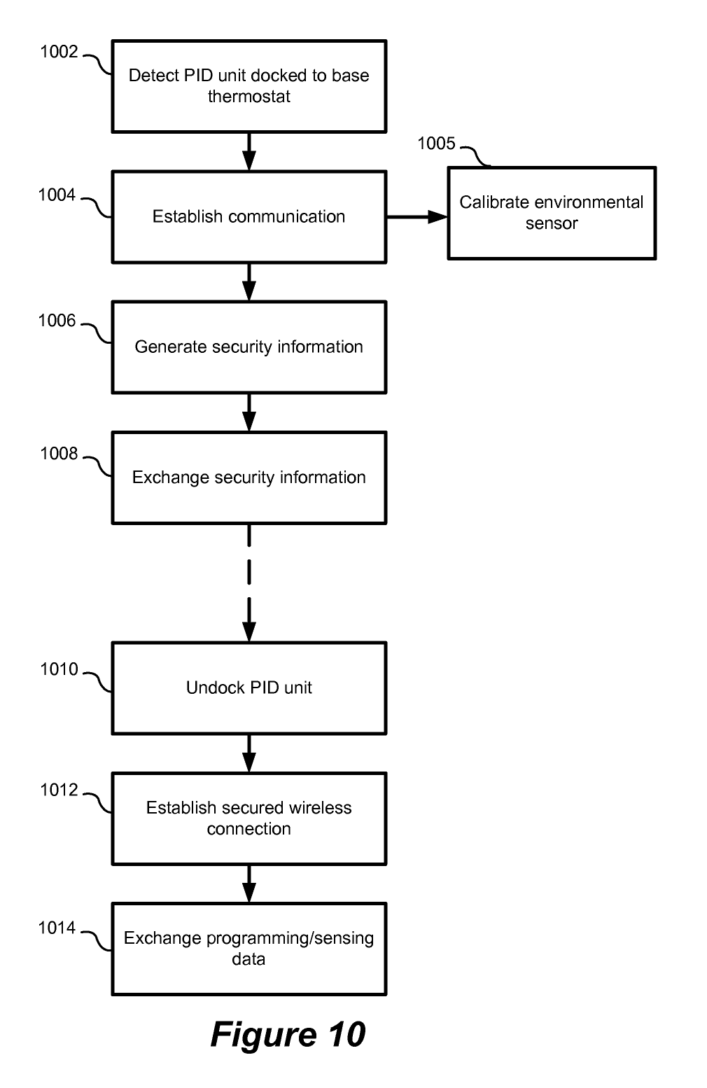

FIG. 10 depicts a method of securing wireless communication between the PID unit 108 and the base thermostat 106. As described above, the PID unit 108 and base thermostat 106 may include a docking interface that can be used to exchange data as well as power. The docking interface may be used to exchange security information between the PID unit 108 and the base thermostat 106 that can be used to secure wireless communications between the devices, providing a simple and secure user experience. For example the PID unit 108 and base thermostat 106 may exchange wireless security keys such as Zigbee™ keys to ensure secure communication. Alternatively security information may be provided to enable wireless access to smart grid wireless infrastructure. The method 1000 begins when the base thermostat 106 determines that the PID unit 108 is docked (1002). Once the PID unit 108 has been docked, a communication channel is established (1004) between the base thermostat and the PID unit 108 using the docking connection, which provides a physical electrical connection between the devices. The establishment of the connection may be initiated by contact of the data connector or by contact of the power connection if communication is performed wirelessly between the base thermostat 106 and PID unit 108. The base thermostat 106 may determine that the PID unit 108 is docked when there is a change in current provided to the connector. Once the communication channel is established the base thermostat may generate or retrieve security information (1006), for example encryption keys, and exchange the security information (1008) with the PID unit 108. Additional security information may also be exchanged between the two devices, for example additional security information used to connect to other communication networks in the building. For example, Zigbee™ based mesh networks may require security information to be exchanged before a device can join the mesh network.

When provisioning the base thermostat, a utility qualified installer must provide to the head office server the install keys and MAC address for the installed thermostat before an energy trust center (smart electric meter, etc,) allows the thermostat joining the ZigBee Smart Energy network. This information may be available via the thermostat display or a database associating the thermostat's serial number to the install keys and MAC address. When the user decides to upgrade the base thermostat with a PID unit, the simple action of docking the PID unit for the first time may generate an automatic provisioning by sending the PID install keys and MAC address via the already established secure network link between the base thermostat and its trust center, and through the trust center, all the way to the head office server. In addition, while the PID unit 108 is docked with the base thermostat 106, the environmental sensors may also be calibrated (1005) between the units to ensure consistency of temperature or any other environmental variable reading when the PID unit 108 is undocked.

At some time after exchanging the security information, the PID unit 108 may be disconnected and undocked (or un-mounted) from the base thermostat 106 (1010). With the PID unit 108 undocked, the PID unit 108 communicates with the base thermostat 106 using an established wireless connection that is secured based on the exchanged security information (1012). Once the wireless connection is securely established, environmental control system control information, power usage information, or other control or display information may be exchanged between the base thermostat 106 and the PID unit 108 using the secured wireless communication channel (1014).

Various features and functions of a thermostat system have been described that allows an environmental control system to be controlled by a base thermostat 106 mounted in a central location. Advantageously, the base thermostat 106 can communicate with a PID unit 108 that can control the base thermostat 106, and so the environmental control system, from remote locations. The PID unit 106 may comprise a sensor for sensing a local environmental condition, which may be used in place or combined with the base thermostat's environmental sensor to control the environmental control system providing improved environmental control based on the user's location. Furthermore, the PID unit 108 may be releasably mounted to the base thermostat 106. When docked or mounted to the base thermostat 106, the PID unit 108 provides the base thermostat with an improved appearance. The dockable PID unit 108 allows consumers to upgrade to an improved base thermostat 106 without requiring any further installation or wiring.

It will be appreciated that functionality described as being provided by either the base thermostat or the PID unit may be provided in various ways. For example, the location based control described with reference to FIG. 9, was described as being implemented on the PID unit, however much of the functionality described, other than tracking the location of the PID unit, could be performed by the base thermostat.

Furthermore, the thermostat system has been described by way of a single base thermostat; however, it is contemplated that the PID unit could be used in buildings with multiple base thermostats, for example controlling different zones or sections of a building.

While the patent disclosure is described in conjunction with specific embodiments, it will be understood that it is not intended to limit the patent disclosure to the described embodiments. On the contrary, it is intended to cover alternative, modifications, and equivalents as may be included within the scope of the patent disclosure as defined by the appended claims. In the description numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

What is claimed is:

1. A portable information display (PID) unit comprising:
a wireless communication interface for communicating with a base thermostat coupled to an environmental control system;
a docking mechanism for releasably mounting the PID unit to the base thermostat; and
a display for displaying environmental control system information retrieved from the base thermostat.

2. The portable information display unit of claim 1, wherein the PID unit provides control of the environmental control system by communicating with the base thermostat.

3. The portable information display unit of claim 2, further comprising an environmental sensor.

4. The portable information display unit of claim 3 wherein the environmental sensor is calibrated relative to an environmental sensor in the base thermostat when docked.

5. The portable information display unit of claim 3, wherein the environmental control system is controlled based on the environmental sensor of the PID unit when remote from the base thermostat.

6. The portable information display of claim 1, wherein the PID unit comprises a docking interface for communicating with the base thermostat and charging a battery of the portable thermostat control when mounted to the base thermostat.

7. The portable information display of claim 6 further comprising exchanging security key information with the base thermostat through the docking interface, the security key information for communication with a smart grid infrastructure.

8. The portable information display unit of claim 1, further comprising a mapping mode to associate a location of the PID unit to one or more environmental control system control settings to allow the base thermostat to automatically control the environmental control system in accordance with the associated one or more environmental control system control settings when the PID unit is in the location.

9. The portable information display unit of claim 8, wherein the PID unit determines its location using one or more of:
data from one or more accelerometers accumulated since the last time the PID unit was mounted to the base thermostat;
triangulation from a plurality of wireless communication devices; and
an indication from a user of the PID unit.

10. The portable information display unit of claim 1 wherein the display is a touch screen display for displaying information received from the base thermostat and for providing user input to base thermostat.

11. A thermostat system comprising:
a base thermostat coupled to an environmental control system to control operation of at least one component of the environmental control system; and
a portable information display (PID) unit comprising a display, providing a docking mechanism to releasably mount the PID unit to the base thermostat, the PID unit communicating with the base thermostat to enable controlling the base thermostat via the PID unit.

12. The thermostat system of claim 11 wherein the base thermostat further comprises a display and wherein the PID unit covers the display of the base thermostat when mounted to the base thermostat.

13. The thermostat system of claim 12 wherein the base thermostat further comprises an environmental sensor for sensing an environmental condition to control the environmental control system relative to the sensed environmental condition and the PID unit further comprises an environmental sensor for sensing an environmental condition and for controlling the environmental control system relative to the sensed environmental condition by communication with the base thermostat.

14. The thermostat system of claim 13 wherein the base thermostat environmental sensor or PID unit environmental sensor can be calibrated relative to each other when the PID unit is docked to the base thermostat.

15. The thermostat system of claim 11 further comprising a charging interface between the base thermostat and the PID unit to provide a charging current to the PID unit when mounted to the base thermostat

16. The thermostat system of claim 15, wherein the charging current is from a 24 VAC transformer provided by the environmental control system to the base thermostat.

17. The thermostat system of claim 11, further comprising a data interface between the base thermostat and the PID unit to provide a communication interface to the PID unit when mounted to the base thermostat.

18. The thermostat system of claim 17 wherein the data interface is for exchanging security key information for communication with a smart grid infrastructure between the base thermostat and the PID unit.

19. The thermostat system of claim 11 further comprising a wireless data interface between the base thermostat and the PID unit to provide a communication interface to the PID unit.

20. The thermostat system of claim 11, further comprising:
at least one additional base thermostat for controlling an environmental condition in a zone separate from the base thermostat, wherein the PID unit may communicate with the at least one additional base thermostat and be mounted to the at least one base thermostat.

21. The thermostat system of claim 11, wherein the PID unit is releasably mountable to the base thermostat using a docking mechanism that is part of the PID unit, part of the base thermostat, or part of both the PID unit and the base thermostat.

22. The thermostat system of claim 11 wherein the display is a touch screen display for displaying information received from the base thermostat and for providing user input to base thermostat.

23. A method of operating a thermostat system, the method comprising:
detecting, in a base thermostat, when a portable information display (PID) unit is docked to the base thermostat;
establishing communication between the base thermostat and the PID unit; and
exchanging security information between the base thermostat and the PID unit;
wherein the security information is used to enable wireless communication between the base thermostat and the PID unit when undocked.

24. The method of claim 23 wherein the security information is associated with a smart grid infrastructure accessible through the base thermostat.

25. The method of claim 23 further comprising calibrating an environmental sensor in the base thermostat with an environmental sensor in the PID unit.

26. The method of claim 23 wherein establishing the communication between the base thermostat and the PID unit is performed through a connector interface.
